(19) United States
(12) Patent Application Publication
(10) Pub. No.: US 2014/0136216 A1
(43) Pub. Date: May 15, 2014

(54) SYSTEM AND METHOD FOR PROCESSING DATA RELATED TO CASE MANAGEMENT FOR INJURED INDIVIDUALS

(71) Applicant: HARTFORD FIRE INSURANCE COMPANY, Hartford, CT (US)

(72) Inventors: Elizabeth B. Beebe, Rancho Cordova, CA (US); Debra J. Kane, Lisle, IL (US); Glen-Roberts Pitruzzello, Middlefield, CT (US)

(73) Assignee: HARTFORD FIRE INSURANCE COMPANY, Hartford, CT (US)

(21) Appl. No.: 13/674,543

(22) Filed: Nov. 12, 2012

(51) Int. Cl. G06Q 50/22; G06Q 40/08

(52) U.S. Cl. 705/2

(57) ABSTRACT

A computer system for processing data relating to medical claim management includes data storage devices storing data relating to medical claims, system users having multiple levels of experience, and rules data; and a claim management hardware server in communication with the data storage devices and with devices accessible to the system users. The server is configured to: determine whether a claim is to be assigned from one system user to another one of the system users based on one or more of time-based and event-based triggers, responsive to determining that the claim is to be assigned to another one of the users for short-term review, assign the claim to another one of the system users at the determined level of experience; and notify the another one of the system users via one of the devices accessible to the system users of the assignment.

### FIELD OF INVENTION

The present invention relates to computer systems, and particularly to computer systems for use in case management relating to injuries to individuals.

### BACKGROUND

Administration and allocation of services related to injured individuals may arise in a variety of contexts. By way of example, workers compensation insurance providers furnish services related to employees injured in connection with the performance of their employment duties.

Insurance companies administer workers compensation claims typically through claim handlers and case managers. Case managers have a high level of medical education and experience, and may be, for example, registered nurses with a minimum level of experience. Claim handlers typically have a level of on the job training but do not have the medical educational training of case managers.

Inefficiencies in administration of claims for injuries may occur if case managers are performing tasks that can be performed by less highly trained and less expensive claim handlers. Claims may be handled with insufficient expertise if claim handlers attempt to administer claims with complex medical issues. For example, delays may be experienced in the return of injured employees to work. Proper determination of whether a given symptom or condition is related to a work injury and therefore covered by workers compensation may often require the medical expertise of a case manager.

Systems and methods that provide for efficient allocation of resources to cases involving injured individuals are desirable for reasons including reduction in costs of administration and facilitating recovery of individuals to be able to resume employment duties.

### SUMMARY

In an embodiment, a computer system for processing data relating to medical claim management includes data storage devices storing data relating to medical claims, system users having multiple levels of experience, and rules data; and a claim management hardware server in communication with the data storage devices and with devices accessible to the system users. The server is configured to: access from one or more of the plurality of data storage devices data relating to one of a plurality of medical claims and a system user assigned to the claim for long-term oversight; determine based on the accessed data relating to the claim and rules data stored in one or more of the plurality of data storage devices whether the claim is to be assigned to another one of the system users for short-term review and the level of experience of the another system user; responsive to determining that the claim is to be assigned to another one of the users for short-term review, assigning the claim to another one of the system users at the determined level of experience; and notify the another one of the system users via one of the devices accessible to the system users of the assignment.

A computer-implemented method for processing data relating to medical claim management includes accessing by a claim management hardware server from one or more of a plurality of data storage devices data relating to one of a plurality of medical claims and a system user assigned to the claim for long-term oversight; determining by the claim management server based on the accessed data relating to the claim and rules data stored in one or more of the plurality of data storage devices whether the claim is to be assigned to another one of the system users for short-term review and the level of experience of the another system user; responsive to determining that the claim is to be assigned to another one of the users for short-term review, assigning by the claim management hardware server the claim to another one of the system users at the determined level of experience; and notifying by the claim management hardware server the another one of the system users of the assignment via one of a plurality of devices accessible to the system users.

In an embodiment, a non-transitory computer-readable storage medium has processor-executable instructions stored thereon relating to processing of data for medical claim administration, which instructions, when executed by the processor, cause the processor to: access from one or more of a plurality of data storage devices data relating to one of a plurality of medical claims and a system user assigned to the claim for long-term oversight; determine based on the accessed data relating to the claim and rules data stored in one or more of the plurality of data storage devices whether the claim is to be assigned to another one of the system users for short-term review and the level of experience of the another system user; responsive to determining that the claim is to be assigned to another one of the users for short-term review, assign the claim to another one of the system users at the determined level of experience; and notify the another one of the system users of the assignment by providing data indicative of the notification over a network addressed to one of a plurality of devices accessible to the system users.

### BRIEF DESCRIPTION OF DRAWINGS

FIG. 1 is a schematic diagram showing an environment in which a computer system for providing case management related data processing may be implemented.

FIG. 2 is a schematic diagram of an exemplary system for case management data processing.

FIG. 3 shows a system including a user device and associated screen display for use by a claim handler in an implementation of a method and system of the invention.

FIGS. 4A and 4B are an exemplary flow diagram of a process of claim handling and assignment according to an embodiment of the invention.

FIG. 5 is a schematic diagram of an exemplary computer system and associated networked devices in an implementation of a method and system of the invention.

FIG. 6 is a diagram of an exemplary server computer and associated databases and networked devices in an implementation of a method and system of the invention.

### DETAILED DESCRIPTION

It is to be understood that the figures and descriptions of the present invention have been simplified to illustrate elements that are relevant for a clear understanding of the present invention, while eliminating, for the purpose of clarity, many other elements found in typical computer systems and methods for processing of data relating to insurance services and programs such as administration of workers compensation claims. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein.

In medical management of cases relating to injuries covered by a form of insurance, such as workers compensation coverage for injuries sustained in the performance of employment duties, various factors result in unnecessary costs of management or delays in resolving injuries. Among the factors that result in unnecessary costs or delays is the assignment of medical case monitoring and management personnel with either an unnecessarily sophisticated skill set, or the assignment of medical case monitoring personnel with an insufficiently sophisticated skill set or insufficient clinical experience. In a case involving a routine injury, confined to one body part, with no complications, the assignment of a registered nurse with extensive experience in managing cases of this type is typically an inefficient use of resources. By contrast, the assignment of a claim handler without a nursing degree or experience may involve a level of expertise that is insufficient for medical and/or disability management of more complicated cases. Such more complicated cases may result in unnecessary medical costs and delays in the employee returning to work as a result of the application of an insufficient level of expertise to medical and/or disability management of the claim.

In embodiments, a computerized system performs data processing for medical and/or disability management of cases related to injuries, such as workers compensation injuries. The computer system has access to a database of data relating to the cases, including type of injury, date of injury, date of claim submission, history of treatment, time lost from employment duties, identification of employee and employer, and other data. The computer system analyzes claims and determines further claim processing and assignment of personnel dependent on a result of analysis. In embodiments, a system has associated users having a plurality of levels of experience in connection with administration of claims, clinical expertise and authority. The user levels may include clinical leads at a highest level of authority, and having administrative functions, including supervisory tasks such as assignment of users to cases. The clinical leads will in some cases have a highest level of clinical expertise and experience; in other cases, there will be overlap in levels of clinical expertise and experience in claim administration with other users, including case managers. Case managers have a high level of clinical expertise, such as the degrees and certification required for qualification as a registered nurse, and generally substantial experience in medical claim management and thus have expertise suitable for oversight of medical aspects of cases. Clinical triage consultants may be at a level of clinical expertise similar to that of case managers, and may have the degrees and certification required for qualification as registered nurses, but with typically a lesser level of experience in claims administration. Clinical triage consultants generally review medical aspects of a case sufficiently to determine whether there is a need to refer the case to a case manager, or to generate a plan, such as a plan for medical treatment and/or steps to recovery from disability, and forward oversight of the case and implementation of the plan to a claim handler. Claim handlers may have a lower level of authority, and require a lower level of clinical expertise than clinical triage consultants and case managers. For example, claim handlers may not be required to have the educational qualifications and certifications of registered nurses. The system may be configured to review cases based on triggering, such as time elapsed since initiation of a claim, type of activity or the like. The system may be configured to require claim handlers to refer cases to a higher level of clinical expertise based on one or more factors related to diagnoses, treatments performed or recommended, changes in conditions or treatments, or the like. The system may be configured with rules to return the medical management of a case from a case manager back to a claim handler, based on factors such as time elapsed after assignment of the case manager, presence or absence of medical changes, or other data.

The system may be configured to limit the amount of time between assignment of a clinical triage consultant to a case and the disposition of the case by the clinical triage consultant.

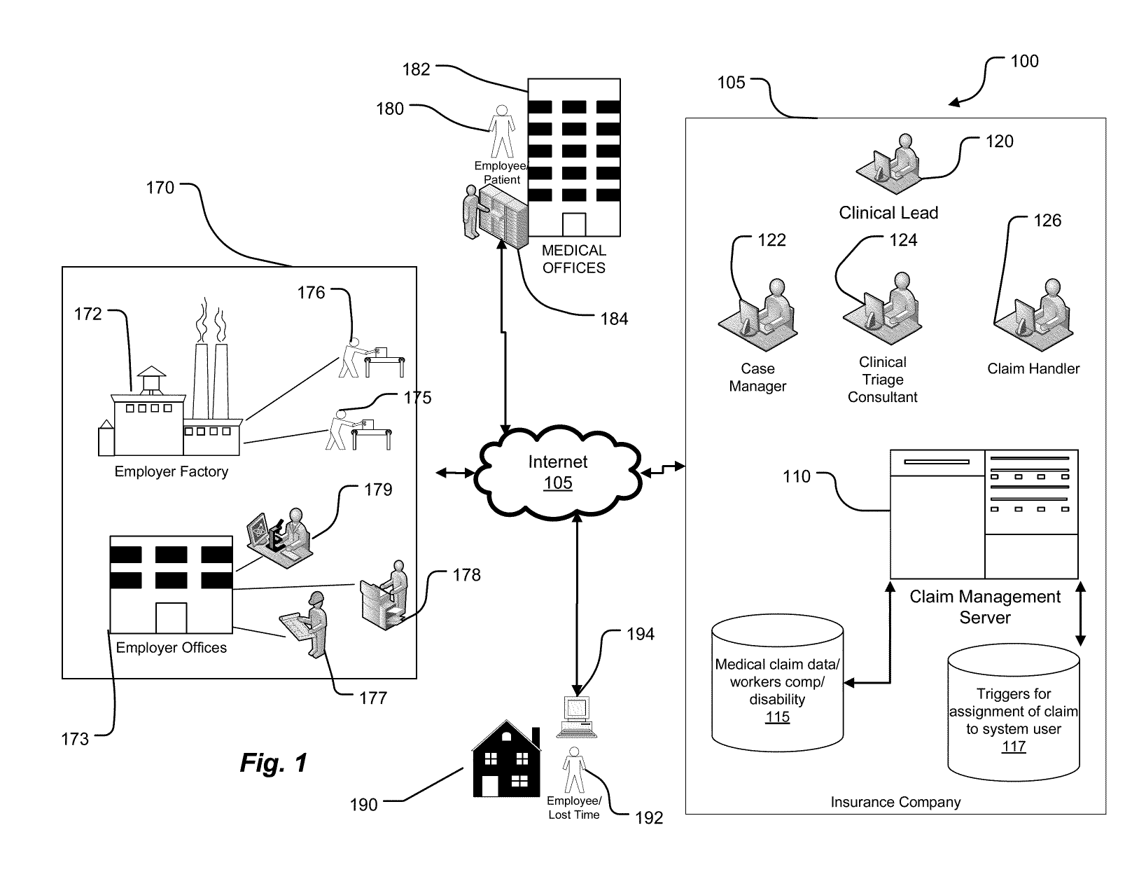

Referring now to FIG. 1, an exemplary system 100 for processing data related to management of medical claims, such as workers compensation and disability claims, is shown in its environment. System 100 includes insurance company 105 elements, which includes medical management system server 110, which may be in communication via an internal network, such as an insurance company intranet or local area network, with claims database 115. Database 115 includes data relating to claims, including employee and employer identities, dates of claim submission, type of injury, treatments and procedures, records of medical evaluations, amounts paid and claimed, and other relevant data. Server 110 is also in communication with database 117 having triggers for assignment of cases to various system users. Exemplary users of system 100 include users 120, 122, 124, 126 operating local devices in communication with claim management server 110. Users 120, 122, 124 and 126 each have a particular level of expertise and authority. In an embodiment, user 120, termed here a clinical lead, has a highest level of authority, including authority to assign claims to a clinical triage consultant or a case manager, and to take actions relating to claims including procurement of prior medical history and mechanism of injury, return to work status, use of medical and disability guidelines, development of plans for rehabilitation or treatment, data integrity, and other tasks. User 122, termed a case manager, may be a medical professional, such as a registered nurse according to educational attainment at least and in some cases state or other jurisdiction licensing, and generally a period of years, such as at least one year to five years, of experience in reviewing and managing medical claims. User 122 may have the authority to take actions relating to claims including procurement of prior medical history and mechanism of injury, return to work status, use of medical and disability guidelines, development of plans for rehabilitation or treatment, data integrity and other tasks, but not all of the authority of the clinical lead 120. User 124, termed a clinical triage consultant, may be a medical professional, such as a registered nurse according to educational attainment at least and in some cases state or other jurisdiction licensing, but may not have the same level of clinical experience in review and management of claims of a case manager. User 124 has responsibility for review of claims, determination whether the claims require assignment of a greater intensity of medical review, such as assignment of a case manager, or can be managed by a claim handler 126. User 124 may have responsibility for developing plans for implementation with respect to specific claims by claim handler 126. User 126 may have a lower level of clinical expertise as it relates to the medical management of cases. Medical management system server 110 is configured to perform data processing tasks including, in response to instructions from a clinical lead, associating a user with a case, testing data relating to cases against stored rules and providing output to users to identify cases that have met thresholds for review or other action according to rules.

The system 100 provides services in the context of employer 170, which may be an insured or have an affiliated insured group providing coverage at a factory location 172 for factory employees 175, 176 and at an office location 172 for professional and clerical employees 177, 178, 179. The coverage may include workers compensation coverage, short term or long term disability coverage, or other coverage involving treatment for injuries that cause the employee to be disabled and unable to perform the employee's customary employment duties. The system 100 may also perform administrative services for an employer 170 that self-insures, or may perform administrative and/or data processing services on behalf of another insurance entity that underwrites coverage for employer 170.

Injured employees, such as employee/patient 180, may be examined and treated at medical offices 182. Computer system 184 used by office staff of medical offices 182 may be in communication with claim management server 110 via one or more networks, such as Internet 105, and provide data relating to diagnoses, recommended and performed procedures, amounts billed for performance of office visits, procedures and tests, and other data to claim management server 110, such as in response to inquiries by system users 120, 122, 124, 126.

Injured employees may also be out of work and at home 190, such as employee 192, whose presence represents a lost time claim. Data may be provided by employee 192 as to the activities and abilities of employee 192, such as the ability of the employee to perform tasks, performance of rehabilitative exercises, and other data relating to rehabilitation of the employee, using for example a home computer 194 to claim management server 110.

Claim management server 110 may provide communications to employees 182, 192, regarding such matters as approved time away from work, compliance with rehabilitation programs, approved medical providers, and other data. Similarly, data relating to the injury and rehabilitation may be provided to employer computer systems, subject to confidentiality requirements.

A web server or a printing and mailing system may serve as a communications interface for providing reports and other communications to employee, providers, employers and others from the claim management server 110. A printing and mailing system may include machinery for printing, folding, envelope stuffing and application of postage using automated postage meters, supplied by Neopost or other vendors.

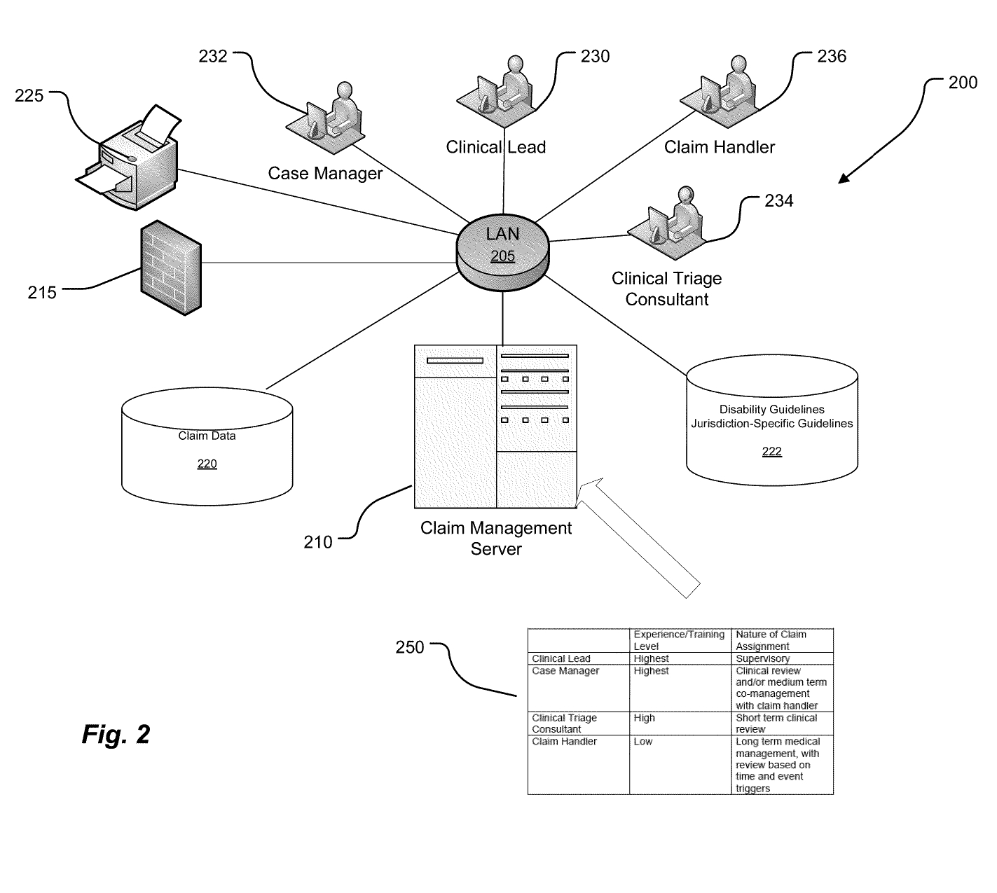

Referring to FIG. 2, an exemplary system 200 according to an embodiment of the invention is shown. In this embodiment, an insurance company local area network 205 provides data communication among claim management server 210, data sources 220, 222, exemplary printer 225, and insurance company users including clinical lead 230, case manager 232, clinical triage consultant 234 and claim handler 236. Communication with other networks may be via firewall 215. Claim management server 210 may access claim data from claim database 220 and apply suitable rules. Exemplary rules relating to levels of users, nature of claim assignment and nature of completion of assignment are summarized in table 250. For example, claim management server 210 may on a periodic basis, such as a daily basis, review claims against a plurality of rules related to timing. The rules may specify that new claims are assigned to a clinical lead 230. The clinical lead may be presented with a system screen that presents data relating to the new claim, and provides a menu of options, including an option of assignment of the new claim to a claim handler or to a claim handler with concurrent assignment to another insurance company user. The server receives the assignment, and associates the claim with the assigned insurance company user. In a typical situation, the assignment is to a claim handler. The server permits the claim handler to access data relating to the claim, provides notification to the claim handler of events relating to the claim, such as receipt of data indicative of developments relating to the claim, and may provide prompts to the claim handler. The server is configured to update and to access data relating to claims and to identify files for review by another user based on receipt or accessing of data indicative of one or more triggers, such as type of injury, type of procedure, and/or time elapsed subsequent to an event such as a prior review.

The system may be configured to identify claims assigned to a user having a lower level of clinical expertise or experience, such as claim handler 236, based on a factor such as time elapsed subsequent to a review by a user having a higher level of expertise or experience, or other factors. In an example, any claim open beyond a certain time period, such as 60 days, 90 days, 120 days, or another time period, is identified by the system as being for review by a user having a higher level of expertise. In another example, the time period and criteria may be dependent upon data relating to the claim. For example, the system may be configured to identify for review by a user having a higher level of expertise each claim for medical benefits only, and no lost time benefits, open beyond a first time period, and identify, for review by a user having a higher level of clinical expertise, each claim having lost time incurred that is open beyond a second, longer time period. In an embodiment, the system may be configured to identify, such as in a report, each claim relating to indemnification and open beyond a predetermined time period.

Upon identification of a claim as requiring review, the system may be configured to assign a clinical triage consultant to the claim. In embodiments, the system may be configured to notify a manager, such as a clinical lead, that the claim is due for assignment to a clinical triage consultant, and receive data indicative of the assignment by the clinical lead of the assignment. The system may be configured to require the clinical triage consultant to complete review and recommendations within a relatively short time period. Examples of a suitably short time period include generally time periods of about one to three business days for cases in which all data required is in the system, or 5 days, 10 days or 20 days, by way of example for cases in which the clinical triage consultant must obtain data from other sources. The system may be configured to permit clinical triage consultants to access data relating to claims upon assignment to the claim.

The system may prompt the clinical triage consultant to perform each of the following tasks as part of a review of a case: review of all documents and data reflecting any investigation previously conducted through contacts with any of the injured individual, emergency room or urgent care, and other medical providers; review of electronic data records and performance of clinical analysis to identify inconsistent findings and whether the information available is sufficient for completion of a review; and contact with medical providers, injured individuals and any others as needed to complete a review. The system may be configured to prompt or remind the clinical triage consultant to review and analyze data including: medical history of the individual prior to the injury; co-morbidities between the injury and other conditions and/or between conditions prior to the injury and other conditions; medical causation relating to reported injuries; status of the individual's return to work; availability of transitional work or modified duties for injured employees; changes in body sites of injury, nature of injury or nature of claimed illnesses. Co-morbidities may be important in determining whether a new condition or an injury to a new body part, e.g., an injury to the right arm of an injured employee having a claim for an on-the-job knee injury, is covered under a workers compensation policy.

The system is configured to receive input data in a suitable format, which may include free text and/or structured formats with particular topics, menu driven selections or otherwise, for each of the following areas: (1) prior medical history, including results of investigation, co-morbidities for conditions relating to prior medical history, prior injuries and conditions; (2) mechanism of injury; initial diagnosis, current diagnosis, causation, onset of symptoms, history of symptoms, current symptoms, history of treatment, comment on all body parts and conditions involved; (3) return to work status, including transitional work or accommodations available; (4) material changes in claimed body site, injuries or illnesses; (5) guidelines, including pertinent medical treatment and disability guidelines; (6) medical plan and/or disability plan recommendations. The system is configured to accept abbreviations, such as in free text input screens, in a suitable format. The system may present separate data screens for exemplary types of data, such as: A screen or section configured for input of injury details; a screen configured for input of return to work data, including transitional work or accommodations; a screen for input of a treatment plan; and a screen for input of causal factors for the symptom or condition, including causal factors, such as data from prior medical history, that indicate that the symptom or condition is not related to the injury. In embodiments, the number of screens, pages or fields and the topics associated with each screen, page or field may vary.

The system is configured to provide treatment guidelines, disability guidelines and jurisdiction-specific guidelines for display and review by system users. Treatment guidelines may be industry accepted guidelines for steps in treatment of a particular condition or injury. Disability guidelines may be industry accepted guidelines to determine whether a particular injury or results of testing of an injured employee indicate disability with respect to a particular job or task. Jurisdiction-specific guidelines relate to treatment and/or disability guidelines that are employed in certain jurisdictions and not in others, such as guidelines promulgated by the State of California.

The system may prompt the clinical triage consultant to attach or associate electronic documents stored in one or more databases and associated with the file, such as images of medical records, permanent disability award documents, physical capacity evaluation documents or other documents. The system may be configured to require the clinical triage consultant to input text descriptive of the document, which text is associated with the document in a suitable database. By way of example, a suitable description of a medical record such as an X-Ray or MRI may include a type of image, body part depicted, date image was taken and entity that took the image. An example is “MRI of left shoulder from Feb. 5, 2007 by Medfocus.”

The system may be configured to require a clinical triage consultant to complete certain tasks prior to returning the claim and/or disability management of the claim to another system user. The clinical triage consultant may be required to complete and document a synopsis of the claim, anticipated medical/disability plan and future clinical intervention points. The clinical triage consultant may be required to document that all efforts have been completed to secure necessary information in order to complete the consultation. The clinical triage consultant may be required to complete designated elements of a file strategy.

In embodiments, the system may be configured to require 24 hour turn-around-time by the clinical triage consultant as the short-term review when all information is present in the claim file. The system may be configured to permit a longer period, such as a maximum of 7 day turn-around-time, when additional information is needed to complete the consultation. The system may be configured to provide on-screen prompts or prompts to cellular telephones or other mobile devices or landline telephones via e-mail, text messaging, pre-recorded calls and other manners, when a deadline is approaching.

In order to complete a review, the clinical triage consultant may be required by the system to document a complete synopsis of the review. The rules may include rules and tools to check a synopsis for completeness and consistency with stored data relating to the claim. The following fields or screens may be required to be completed: injury details; return to work (RTW) screen, including estimated RTW date; causal factors and treatment plan, including treatment authorization from authorized personnel. Upon completion of a review, the system may assign the case to a claim handler, or to a case manager, in accordance with recommendations of the clinical triage consultant.

As the clinical triage consultant is assigned to a case for a short term period, the resources of the clinical triage consultant are used relatively efficiently. The availability of clinical triage consultants to review cases in which complex triggers arise, or which have been assigned to a claim handler for an extended period of time, facilitates proper management of cases, even though the additional expertise of the clinical triage consultant is applied for a relatively short period, while routine tasks are handled by the case manager.

The system may be configured to provide requirements for case managers to close a case, in addition to requirements for case managers to cease direct management of a case within a certain time period, such as a 90 day time period. The requirements for closure that the system may require the case manager to document may include: discrepancies related to the medical and disability guidelines have been addressed or resolved; Injured individual has achieved maximum medical improvement (MMI); compensability of the claim is denied and no additional clinical consultation is necessary/requested; claim is denied for no coverage; death of the injured individual; the injured worker's representative or attorney specifically requests case manager closure and/or if jurisdictionally required; the claim is settled full and final; transitional duty work restrictions are in place for an extended period of time; there is no job for the injured worker to return to (i.e. lay off, termination, permanency) and none applicable full case management parameters apply.

The system may implement the following rules related to completion of a task by a case manager: Full case management may remain open for no more than a maximum period, such as 60, 90 or 120 days in order to achieve case management goals. The system requires as a default that the goals of clinical task assignments can be achieved within 10 business days of the assignment. However, the system may be configured to permit a system user to grant approval for a clinical task to take a longer period, such as up to 30 days to complete.

At the time of case management closure, the case manager must meet the following rule requirements: document the following within the case management system: the date and time of closure; closing rationale; the injured worker's work status at the time of closure; if the injured worker is released to transitional work, provide an estimate of the full duty return to work date; the disability duration and whether it was within or outside guidelines and the corresponding rationale; a synopsis of treatment rendered and whether it was within or outside of guidelines and the corresponding rationale; an estimate of any future medical treatment; closing phone call was made and/or a closure letter was sent to the injured worker and/or their representative, with a copy to the treating provider.

The system is configured to permit the medical management of a case to be returned by a case manager to a claim handler upon completion of a case summary. System rules require a claim summary to include, by way of example: the injury event, the injured worker's age, diagnosis, and any hindering factors that may achieving maximum medical improvement; special instruction/recommendation to the claim handler, such as Contact Dr. Smith after May 1, 2010 appointment to secure permanent partial rating; re-open indicators such as: a change in medication, a request to a specialist, change in work status, indication for surgery; date that case management closure letter was sent; and case manager name. The system will then return the medical management of the case to a claim handler for further monitoring and oversight in accordance with the instructions and recommendations. Upon occurrence of a re-open indicator, the claim handler is to request assignment of the case manager; the system may be configured to review re-open indicators and prompt the claim handler for assignment of the medical and/or disability management of the case to a case manager. The system may be configured to reflect that the medical and/or disability management of the case is assigned to both the claim handler and the case manager. The system may be configured to automatically assign medical management and/or disability management of the claim to a case manager.

By limiting the time period that a case manager may directly oversee a case, and requiring the case manager to provide a detailed case summary to guide a claim handler, efficiency is obtained in use of the time and expertise of the case manager, while still maintaining high quality of overall case management.

The system may be configured, employing stored rules for example, to prompt or require a claim handler to refer a case for review by a case manager or a clinical triage consultant based on one or more event-based factors or triggers. In embodiments, the triggers that will require referral from a claim handler to a clinical triage consultant may include any one of: a request for a type of surgery, other than types serious enough to require referral to a case manager; total temporary disability without a return to work plan; certain diagnoses, such as a diagnosis of carpal tunnel syndrome; an MRI on the neck or the back with written results or an accompanying report; or an introduction of a new body site of an injury, or a new condition. Factors that will require referral from a claim handler to a case manager may include generally more serious conditions, including: a request for spinal surgery; an inpatient hospital stay; a claim of medical causation or relatedness to an underlying injury; a request for a cost projection for a claim; a periodic maintenance review; a treatment or disability cost approaching or exceeding a threshold, such as a threshold for coverage under another policy; or the additional of multiple non-adjacent body sites to an injury claim.

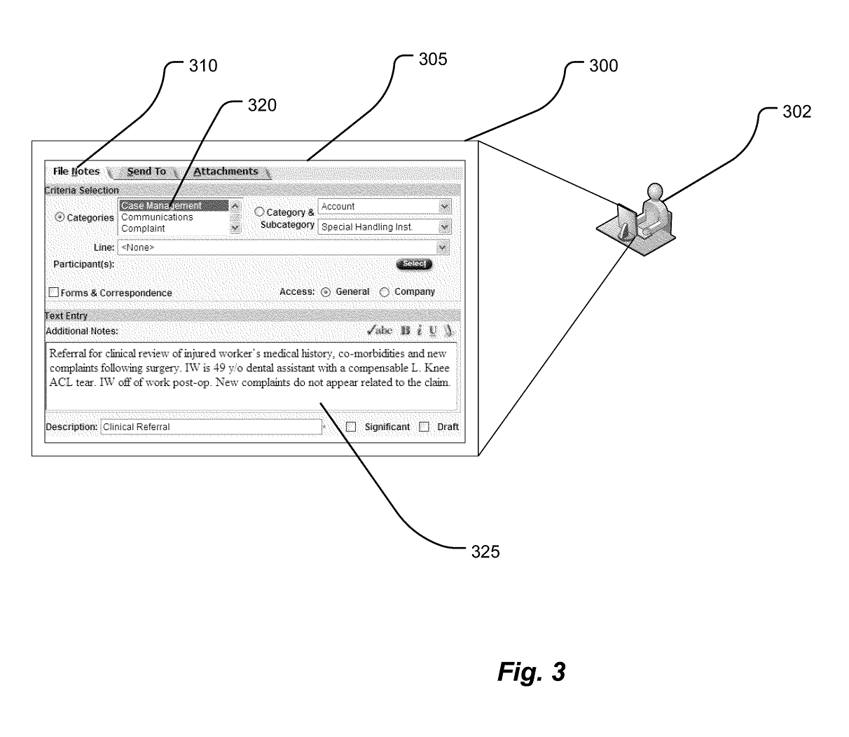

Referring to FIG. 3, an exemplary system of an embodiment of the present invention is shown, displaying a screen displayed on a user device 300 employed by user 302. In the embodiment of FIG. 3, user device 300 is a computer system a processor, memory devices and a display configured for video output. User device 300 is providing a display in response to identification of data indicative of a need for referral to a case manager. In the displayed screen 305, a file notes tab 310 is shown. The user is prompted to select a category, which in this example is the selected category case management selected from drop down menu 320. The user has input in free text in “Additional Notes” field 325 data related to the referral, including a claim of new complaints that do not appear to be related to an original injury, requiring a review for medical causation, such as by a case manager.

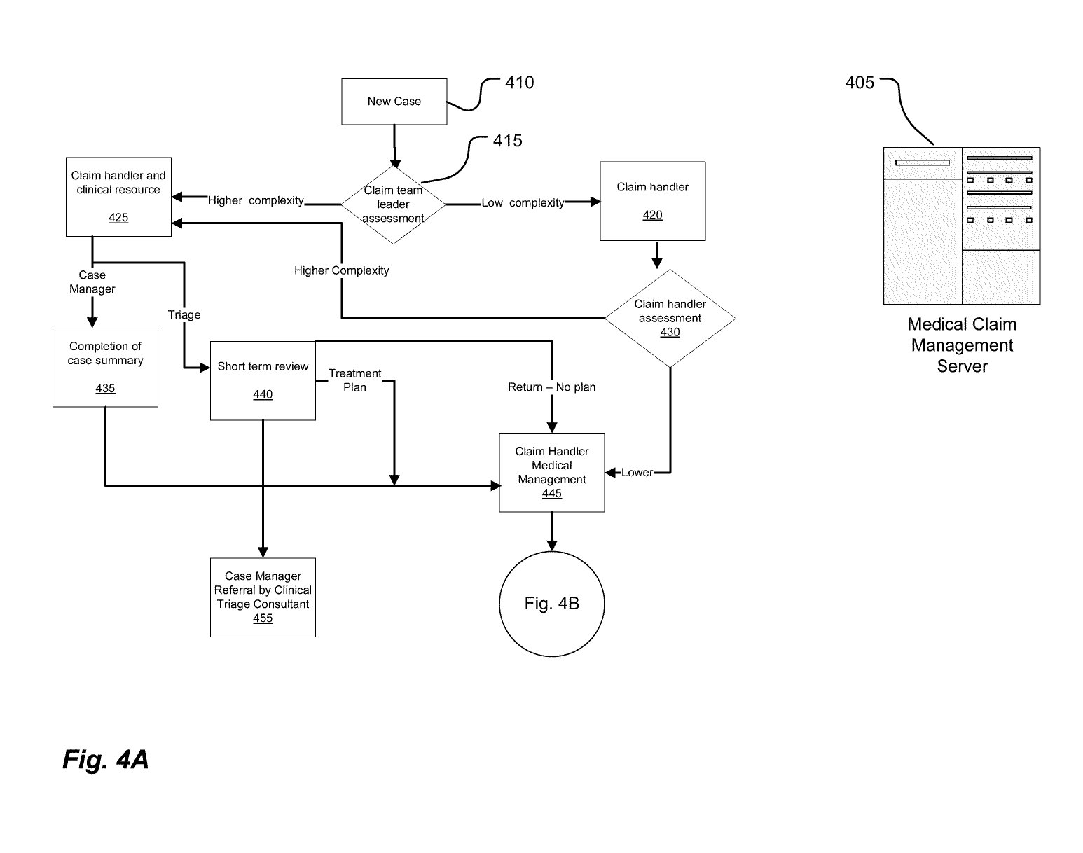

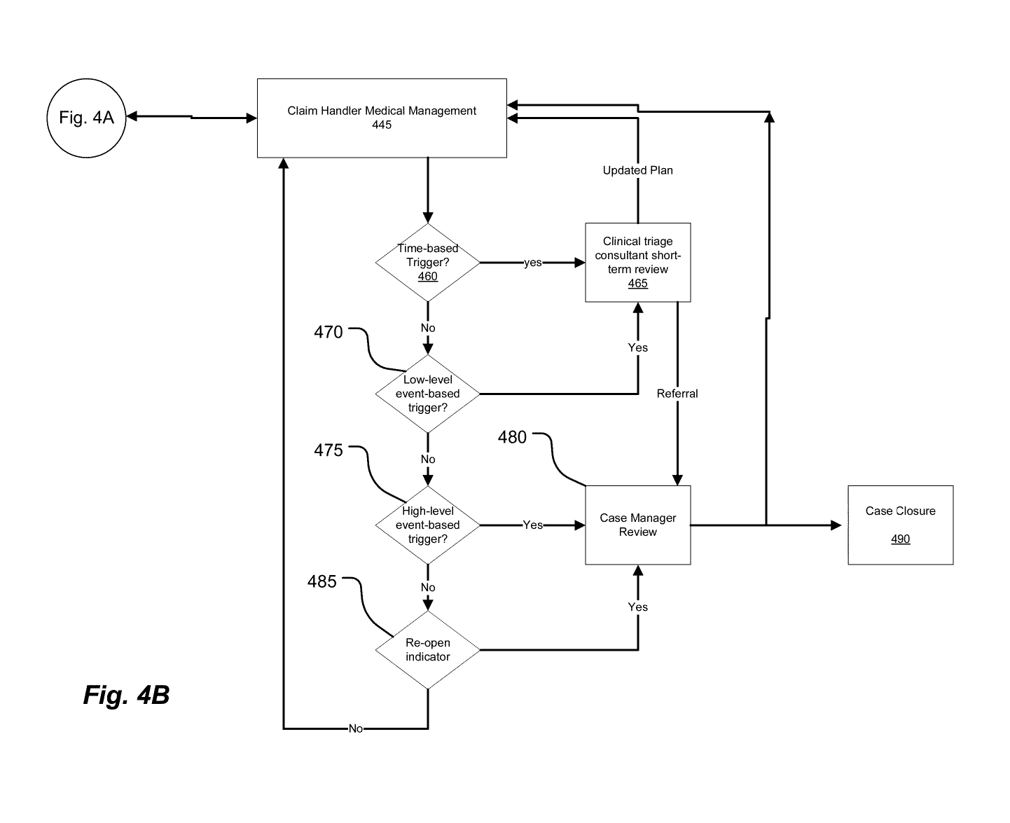

Referring to FIG. 4, an exemplary process flow implemented by a system of the invention is illustrated. Medical claim management server 405 may implement data processing for this method. A new case 410, such as a new workers compensation claim based on an injury of an employee at work is reported and received. The case is assigned to a claim team leader. The claim team leader performs an assessment 415 of the level of medical complexity of the claim. If the claim team leader assesses that the claim has a low level of medical complexity, the claim is assigned 420 to a claim handler alone, and no case manager or clinical triage consultant is assigned to the claim. If the claim team leader assesses that the claim has a greater level of medical complexity, the claim team leader assigns 425 the claim both to a claim handler and to a clinical resource. The system may be configured to generate on-screen prompts for the claim team leader to assign the case. The system may be configured to, responsive to receipt of a claim team leader decision to assign the claim to both a claim handler and a clinical resource, prompt a clinical lead to select a case manager or a clinical triage consultant to serve as the clinical resource assigned to the claim.

For cases assigned to a claim handler alone, the claim handler obtains additional data relating to the claim, such as reports of injuries, telephone calls and other communications with claimants, and other suitable data. As the claim handler has additional data not available to the claim team leader, the claim handler then performs a further assessment 430 of the medical complexity of the claim to determine whether a clinical resource is warranted. If the claim handler determines that a clinical resource is warranted, the claim handler may input data requesting assignment of a clinical resource. The system may then prompt a clinical lead to select a case manager or clinical triage consultant to serve as the clinical resource assigned to the claim.

If the case is assigned to a case manager, the case manager will review the case, collect necessary data, and complete a case summary 435, which will then be provided to a claim handler to perform further medical management. The case manager may remain involved in medical and/or disability management of the case together with the claim handler for a period of time.

If the case is assigned to a clinical triage consultant, the clinical triage consultant will perform a short term review 440. Upon completion of the short term review, the clinical triage consultant may generate a treatment plan and/or a disability plan, which plan is then provided to the claim handler. Alternatively, upon completion of the short term review, the clinical triage consultant may recommend that the claim be referred to a case manager 455 for more complex medical and/or disability management. The clinical triage consultant may return the case to the claim handler without a treatment plan and/or disability plan if the case appears very simple, for example.

Medical management is performed by a claim handler 445 as a result of various events. Referring to FIG. 4B, while medical management is being performed by a claim handler, the system may periodically determine if a time based trigger 460 has been reached. The time based triggers may be based on review every 90 days, every 6 months, every year or other period, for example. If the time based trigger is met, the claim is provided to a triage consultant for short term review 465. If there is no time-based trigger, the system may determine if a low-level event-based trigger, such as a back or neck MRI with a written report, is present 470, in which event the case is also assigned to a clinical triage consultant. As will be understood, upon completion of clinical triage consultant review, the medical and/or disability management of the case may be assigned to a claim handler with a revised treatment plan and/or disability plan, or referred to a case manager for a higher level of clinical review 480. Higher-level clinical review may be indicated if there is data indicating a more complex medical judgment must be made. If there is no low-level event-based trigger, the system may review for a high level clinical event-based trigger, 475, such as spinal surgery. If there is a high-level clinical event based trigger, then the system may assign the case to a case manager for review 480, in addition to the ongoing assignment of the claim handler to the case. If there is no high level clinical event-based trigger, then the case may be reviewed for a re-open indicator 485 specific to the case and designated by a clinical resource, such as a case manager or a clinical triage consultant. In the event that there is a re-open indicator, then the case is assigned to a case manager for review 480, in addition to the ongoing assignment of the claim handler to the case. Clinical review may result in returning the medical and/or disability management of the case to the claim handler with a new summary or closure of the case 490.

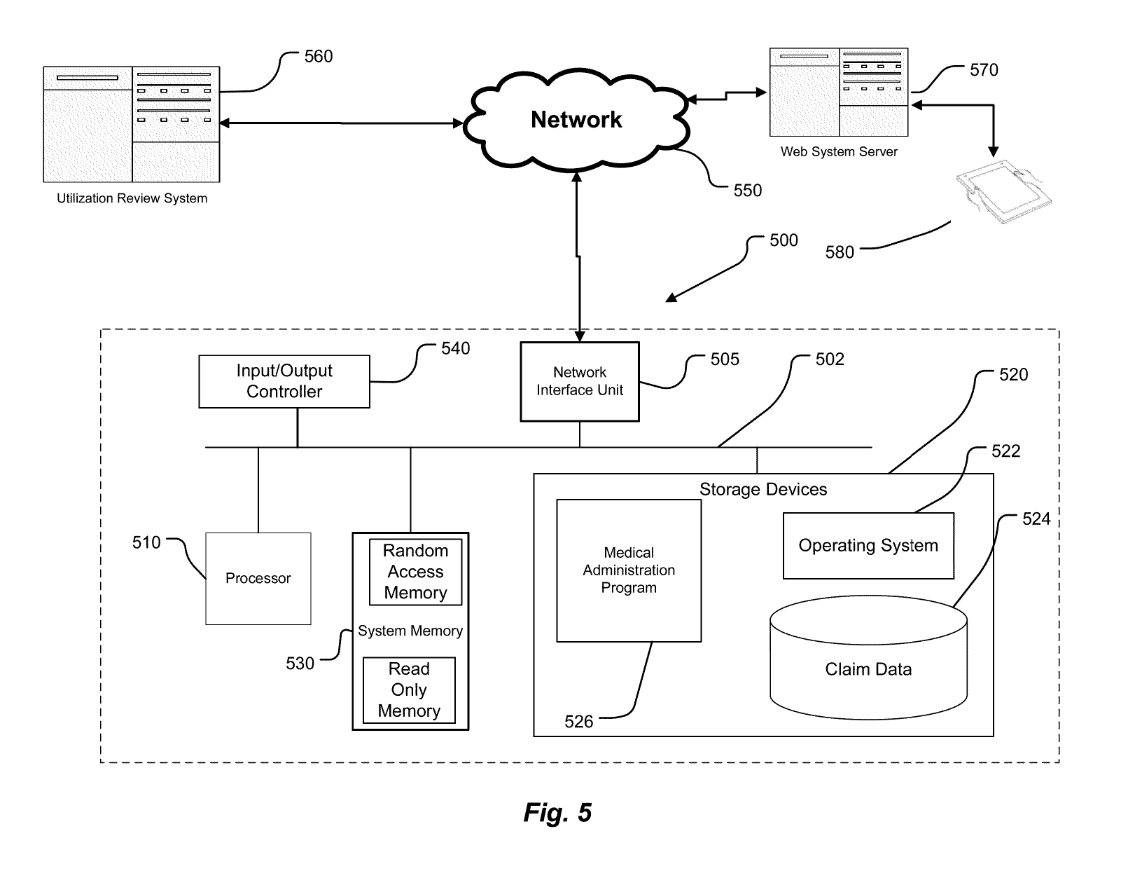

Referring to FIG. 5, an exemplary computer system 500 for use in an implementation of the invention will now be described. In computer system 500, processor 510 executes instructions contained in application programs, which in this example are medical administration programs 526, which programs are stored as processor-executable instructions stored in non-transitory computer-readable storage media, namely storage devices 520. As used herein, the term “processor” broadly refers to and is not limited to a single- or multi-core general purpose processor, a special purpose processor, a conventional processor, a Graphics Processing Unit (GPU), a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit (IC), a system-on-a-chip (SOC), and/or a state machine. Application program 526 may include separate modules for such functions as receiving and classifying data related to claims, determining access to claims data for different classes and levels of users (such as claim handlers, clinical triage consultants, case managers and clinical leads), retrieving data related to claims for review and updating by users, processing data to identify claims to be reviewed by clinical resources; processing data to identify claims to be referred from case managers; providing prompts and interfaces for input of structured data relating to claims, reasons for referrals and other data, by users; providing software tools for users to facilitate review of cases and to assure that all required issues/questions have been addressed in a review.

Storage devices 520 may include suitable non-transitory computer-readable storage media, such as optical or magnetic disks, fixed disks with magnetic storage (hard drives), flash memory, tapes accessed by tape drives, and other storage media. Processor 510 communicates, such as through bus 502 and/or other data channels, with network interface unit 505, system memory 530, storage devices 520 and input/output controller 540. Via input/output controller 540, processor 510 may receive data from user inputs such as pointing devices (including mice and trackballs), touch screens, audio inputs and keyboards, and may provide data to outputs, such as data to video drivers for formatting on displays, data to print drivers for transmission for printing in hard copy or to image files, and data to audio devices.

Storage devices 520 are configured to exchange data with processor 510, and may store programs containing processor-executable instructions, including instructions for implementing accessing and reviewing claim data to identify claims to be reviewed in a short time period by triage consultants, among other available functions. Processor 510 is configured to perform steps in accordance with such processor-executable instructions. Processor 510 is configured to access data from storage devices 520, which may include connecting to storage devices 520 and obtaining data or reading data from the storage devices, or storing new and updated data into the storage devices 520. Storage devices 520 may include local and network accessible mass storage devices. Storage devices 520 may include media for storing operating system 522 and mass storage devices such as claim data 524 for storing data related to claims, including identification of patients, employers, injury details, treatment history, payment data, history of claims management including present plans for management of claims, and other data.

Still referring to FIG. 5, in an embodiment, inputs may include user interfaces, including workstations having keyboards, touch screens, pointing devices such as mice and trackballs, or other user input devices, connected via networked communications to processor 510. Network interface unit 505 may communicate via network 550 with other insurance computer systems, such as utilization review system 560 for use by a utilization review group, and with web system server 570 to permit system access via user devices such as table computer 580. In embodiments, web system server 570 may be configured to generate web documents for display of claim data to users depending on user access rights, to generate web documents to inform users that a claim has met criteria for referral to another user, e.g., from a claim handler user to a triage consultant user, and to generate web documents to prompt users for input of data, such as prompting triage consultants for input of data required for review of a case and forwarding to a claim handler or to a case manager for further handling.

Network interface unit 505 may further communicate with other insurance company computer systems, such as systems related to administration of disability benefits, and with third party systems, such as third party systems having data relating to claimants. By way of example, social media data stored on computer systems of social media services may be accessed by users to assess veracity of changes in claims.

Network 550 may be or include wired or wireless local area networks and wide area networks, and over communications between networks, including over the Internet. Any suitable data and communication protocols may be employed.

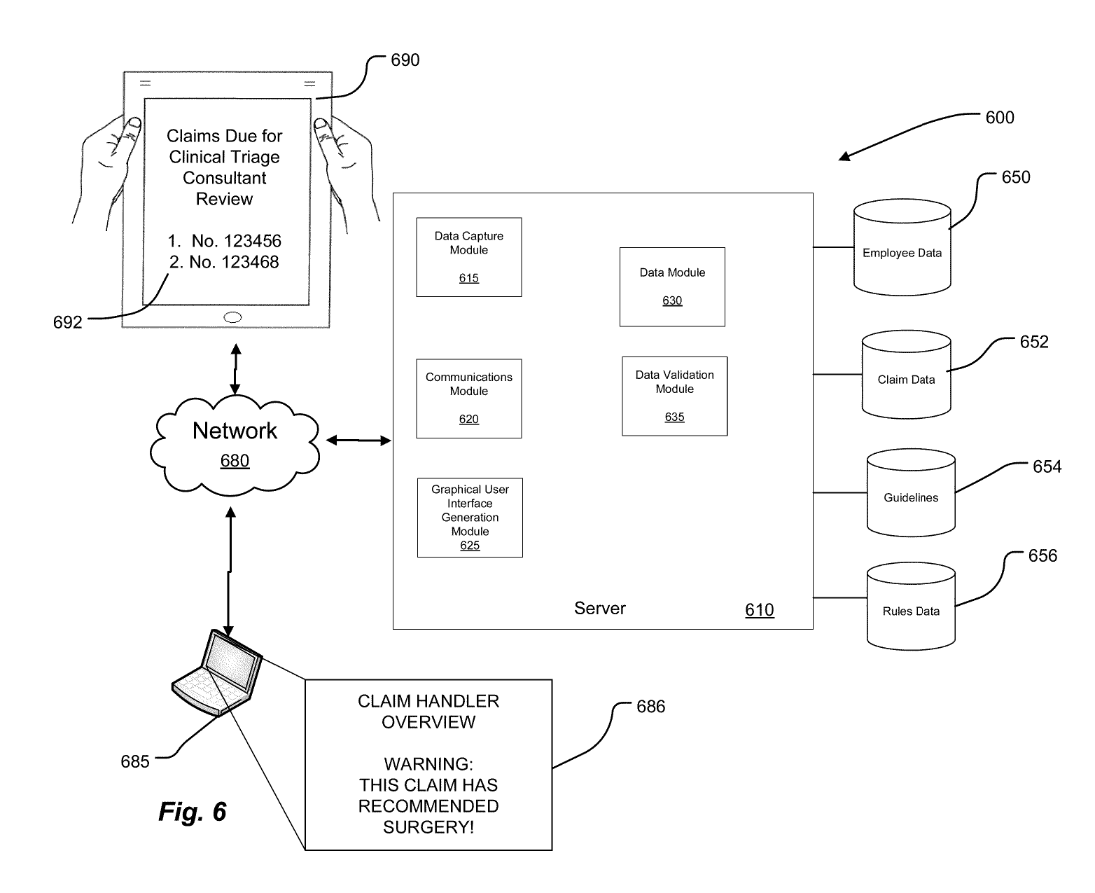

Referring now to FIG. 6, another exemplary embodiment of a system 600 of the present invention is shown. System 600 includes an insurance company hardware server 610 which includes one or more engines or modules which may be utilized to perform one or more steps or functions of embodiments of the present invention. In an embodiment, the present invention is implemented as one or more modules of a computer software program in combination with one or more components of hardware. Such software programs will be used when a system user, such as a claim handler or a clinical triage consultant, has sent a request for data or information to a server and comprises part of the processing done on the server side of the network. Such software programs may also operate on an automated basis, such as a periodic batch basis to access data relating to injury claims and to test the accessed data against one or more rules to determine whether the claims are to be assigned to a clinical resource, such as a clinical triage consultant or case manager, for review, or to be returned for medical and/or disability management from a case manager to a claim handler. In embodiments, data relating to claims may be compared to data set out by a clinical triage consultant as a treatment plan and/or a disability plan to data added subsequently to a claim file by a claim handler.

The programs may be used in an Internet environment, where the server is a Web server and the request is formatted using HTTP (or HTTPS). Alternatively, the server may be in a corporate intranet, and extranet, or any other type of network. Use of the term “Internet” herein, when discussing processing associated with the user's request, includes these other network environments, unless otherwise stated. Additionally, a graphical user interface or other module may be implemented as an intelligent hardware component incorporating circuitry including custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like. One or more functions of a web client or other module may be implemented as application software in the form of a set of processor-executable instructions stored in a memory of a client device, such as tablet computer 690 or laptop 685, and capable of being accessed and executed by a processor of the client device.

Referring still to FIG. 6, server 610 includes a data capture or input/output module 615, a communications module 620, a dynamic display generation or graphical user interface module 625, a data module 630, and a data validation module 635. Data module 630 is in further communication with a number of databases such as employee database 650, claims database 652, guidelines database 654, and rules database 656. Databases 650, 652, 654, 656 may be implemented in one or more physical data storage devices in communication with server 610, or may be implemented in remote data storage devices accessible over one or more networks, such as cloud computer servers accessible via the Internet. Databases in communication with server 610 may include both internal and/or external/third party databases. By way of example, external databases may include databases maintained by medical care providers, health insurers, government agencies and social media service providers. Server 610 may be configured for bulk upload of data, such as bulk upload of data relating to covered employees from an employer database, or data from medical providers relating to treatment provided in connection with claims. Such data may be furnished such as via a spreadsheet file or via suitable xml documents, by way of example. Data may be exchanged between server 610 and one or more legacy systems via suitable middleware systems. One or more modules, such as data validation module 635, may be configured to perform data validation steps prior to storing bulk uploaded data. Data validation module 635 may further serve to verify internal consistency of data entered by one or more users. Server 610 may further be configured to permit bulk download of data, such as data relating to a set of claims for supervisory or audit review, to a device of suitably-authorized user.

In operation, server 610 is in communication with client devices, such as laptop computer 685 or tablet computer 690 via network 680 which facilitates interaction with server 610, such as through web documents, graphical user interfaces and application programs running on client devices 685, 690, as shown and described herein. As used herein, devices, such as client devices 685, 690 may exchange information via any communication network, such as a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network, and/or an Internet Protocol (IP) network such as the Internet, an intranet, or an extranet. Note that any devices described herein may communicate via one or more such communication networks.

Referring still to FIG. 6, utilizing client devices 685, 690, a properly authenticated system user, such as a claim handler or a clinical lead, or a representative of an employer, may access data relating to claims relating to workers compensation. The authenticated user may also furnish data relating to claims updates and evaluations as suitable for the role of the user to server 610 for suitable processing. By way of example, laptop computer 686 may be configured for remote access to server 610 by a claim handler user in the performance of duties relating to processing of claims. The system may be configured to cause a claim handler overview screen to be displayed as display 686 in response to a request from the claim handler to review one of the claims that the claim handler is assigned to monitor and act on. The system may be configured to generate warnings on a display responsive to determining that one or more data items indicative of, according to one or more rules in rules database 656, indicates referral to another class of user. In the example shown in FIG. 6, the system has identified from claims database 652 that surgery has been recommended, and has identified from rules data 656 that data indicative of surgery triggers review by a clinical triage consultant or a claim handler. The system is configured to generate and display as part of display 686 a warning responsive to identifying a trigger. In this warning, the data indicative of the reason for the warning, namely recommended surgery, is displayed for the claim handler, so that the claim handler may appropriately request review by a more experienced level of user.

By way of further example, tablet computer 690 may be configured for review by a clinical triage consultant. Display 692 may be a web document provided to a clinical triage consultant to list claims due for review by a clinical triage consultant, such as by virtue of identification of a time based trigger or an event-based trigger. The system may be configured to list claims in a particular sort order dependent on rules for assigning varying values to triggers, such that a claim with the highest value trigger or triggers is listed first in display 692. The display may include links associated with each identified claim, which, when selected, cause web documents with additional data relating to the claims to be generated and displayed. Web documents including prompts and structured data selections, such as drop down menus, may be generated to facilitate completion of reviews by clinical triage consultants and other users. Data input by users may be uploaded to server 610, which may then proceed with further logic, such as using one or more automated tools to review the completeness and consistency of a clinical triage consultant review of a claim, and for communication of data, such as treatment plans, to claim handlers following review by a clinical triage consultant.

A properly authenticated individual, such as an employee of an insurance company having administrative responsibilities, may access further data and provide updates and modifications to data, such as updates and modifications to rules database 656, such as to add, modify or delete triggers for review of a claim by a clinical triage consultant. Such a user may also have authorization to implement updates to processing logic employed by one or more of the modules 615, 620, 625, 630, 635. In embodiments of the present invention, one or more of the above modules, may also be implemented in combinations of software and hardware for execution by various types of computer processors coupled to such hardware.

As used herein, a module of executable code may, for instance, comprise one or more physical or logical blocks of computer instructions which may, for instance, be organized as an object, procedure, process or function. Nevertheless, the executables of an identified module need not be physically located together, but may comprise separate instructions stored in different locations which, when joined logically together, define the module and achieve the stated purpose for the module such as implementing the business rules logic prescribed by the present system. In embodiments of the present invention a module of executable code may be a compilation of many instructions, and may be distributed over two or more different code partitions or segments, among different programs, and across two or more devices. Similarly, data, including by way of example claims data, employee data, guideline data and rules data, may be identified and illustrated herein within modules, and may be embodied in any suitable form and organized within any suitable type of data structure. Such data may be collected as a single data set, or may be distributed over different locations including over different storage devices, and may exist, at least partially, merely as electronic signals on a system and/or network as shown and described herein.

Throughout processing steps, accessed values, calculated values and draft data, for example, may be stored in temporary memory locations, such as in RAM.

A processor may provide the central processing unit (CPU) functions of a computing device on one or more integrated circuits. The term “processor” may include multi-core processors and central processing units including multiple microprocessors. The central processing unit functionality may be provided at one or more remote locations, such as through application service provider and cloud computing services.

In embodiments, a processor may provide an output signal having data indicative of one or more data items. An output signal may be carried either over a suitable medium, such as wire or fiber, or wirelessly. An output signal may transmit data from one device to another directly, such as over a bus of a computer system from a processor to a memory device, or indirectly, such as over multiple networks, and with intermediate steps of storage in a buffer or memory device and retransmission. Such an output signal may be provided by the processor to a bus of a computer system together with address data at a series of clock intervals. The address data may designate a destination device on a bus, by way of example. In embodiments, an output signal may be a signal output from a hardware communications device of a computer system to a network, such as a local area network, a wide area network, or a network of interconnected networks, such as the Internet. Output signals may include, by way of example, data identifying formats, fields, and content of fields. Signals may be compatible with any appropriate format. For example, data may be formatted in accordance with a data format for insurance data, such as an ACORD compatible format, or a non-ACORD xml format. Reference to an output signal having particular data may include one or more signals bearing the information. Multiple signals bearing the information may include sequences of digital data bearing the information interleaved with sequences of digital data relating to other information. By way of example, a signal may be packetized for transmission. By way of further example, an output signal may take the form of an uncompressed digital signal or a compressed digital signal.

A system on which the methods of embodiments of the present invention may be implemented includes at least one central processing computer or computer network server. A network server includes at least one controller or central processing unit (CPU or processor), at least one communication port or hub, at least one random access memory (RAM), at least one read-only memory (ROM) and one or more databases or data storage devices. All of these later elements are in communication with the CPU to facilitate the operation of the network server. The network server may be configured in many different ways. For example, a network server may be a standalone server computer or alternatively, the functions of a network server may be distributed across multiple computing systems and architectures.

A network server may also be configured in a distributed architecture, wherein databases and processors are housed in separate units or locations. Some such servers perform primary processing functions and contain at a minimum, a RAM, a ROM, and a general controller or processor. In such an embodiment, each of these servers is attached to a communications hub or port that serves as a primary communication link with other servers, client or user computers and other related devices. The communications hub or port may have minimal processing capability itself, serving primarily as a communications router. A variety of communications protocols may be part of the system, including but not limited to: Ethernet, SAP, SAS™, ATP, Bluetooth, GSM and TCP/IP.

Data storage device may include hard magnetic disk drives, optical storage units, CD-ROM drives, or flash memory, by way of example. Data storage devices contain databases used in processing calculations embodied in algorithms, including data for display on client devices and data and rules for determination of whether a claim is to be assigned to another user for review or processing, or whether data input by a user such as a clinical triage consultant is complete. In one embodiment, database software creates and manages these databases. Calculations and algorithms in accordance with an embodiment of the present invention may be stored in storage devices and accessed and executed by a processor, in accordance with instructions stored in computer-readable storage media. Such algorithms may be embodied in modules of program code, or located in separate storage locations and identified in program code by pointers, by way of example.

Suitable computer program code may be provided for performing numerous functions such as verifying data input by claim handlers, generating documents and reports that summarize claims, determine statistical data relating to claims, such as comparison of costs and duration of claims to benchmarks, comparing claims data to reassignment triggers, determination whether a case manager has adequately provided data for closing a claim, and other tasks. The functions described above are merely exemplary and should not be considered exhaustive of the type of function which may be performed by the computer program code of embodiments of the present invention.

The computer program code required to implement the above functions (and the other functions described herein) can be developed by a person of ordinary skill in the art, and is not described in detail herein.

The systems described herein may be in communication with systems including printing and mailing systems, computer systems of employers including human resources departments computer systems, computer systems of medical providers, computer systems of other insurance companies, computer systems of social media service providers, and other computer systems.

The term “computer-readable medium” as used herein refers to any medium that provides or participates in providing instructions to the processor of the computing device (or any other processor of a device described herein) for execution. Such a medium may take many forms, including but not limited to, non-volatile media, non-transitory media, tangible media, volatile media, and transmission media. Non-volatile media and tangible media include, for example, optical or magnetic disks, such as memory. Volatile media include dynamic random access memory (DRAM), which typically constitutes the main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM or EEPROM (electronically erasable programmable read-only memory), a FLASH-EEPROM, any other memory chip or cartridge, a carrier wave as described hereinafter, or any other medium from which a computer can read.

Various forms of computer readable media may be involved in carrying one or more sequences of one or more instructions to the processor (or any other processor of a device described herein) for execution. For example, the instructions may initially be borne on a magnetic disk of a remote computer. The remote computer can load the instructions into its dynamic memory and send the instructions over an Ethernet connection, cable line, or even telephone line using a modem. A communications device local to a computing device (or, e.g., a server) can receive the data on the respective communications line and place the data on a system bus for the processor. The system bus carries the data to main memory, from which the processor retrieves and executes the instructions. The instructions received by main memory may optionally be stored in memory either before or after execution by the processor. In addition, instructions may be received via a communication port as electrical, electromagnetic or optical signals, which are exemplary forms of wireless communications or data streams that carry various types of information.

Servers of embodiments of the present invention may also interact and/or control one or more user devices or terminals. The user device or terminal may include any one or a combination of a personal computer, a mouse, a keyboard, a computer display, a touch screen, LCD, voice recognition software, or other generally represented by input/output devices required to implement the above functionality. The program also may include program elements such as an operating system, a database management system and “device drivers” that allow the processor to interface with computer peripheral devices (e.g., a video display, a keyboard, a computer mouse, etc).

An exemplary advantage of a method and system of the present invention is that a system that implements embodiments makes more efficient use of personnel resources and may reduce costs, avoid payments for conditions not related to injuries covered by insurance, and speed return to work of injured employees.

While particular embodiments of the invention have been illustrated and described, various modifications and combinations can be made without departing from the spirit and scope of the invention, and all such modifications, combinations, and equivalents are intended to be covered and claimed.

What is claimed is:

1. A computer system for processing data relating to medical claim management, comprising:
a plurality of data storage devices storing: data relating to medical claims; data relating to system users, comprising claim handlers, clinical triage consultants and case managers, the clinical triage consultants and case managers having a greater level of clinical expertise than the claim handlers; and rules data;
a claim management hardware server in communication with the plurality of data storage devices and with a plurality of devices accessible to the system users, the server configured to:
access from one or more of the plurality of data storage devices data relating to one of a plurality of medical claims and a claim handler assigned to the claim for long-term medical management;
determine based on the accessed data relating to the claim and rules data stored in one or more of the plurality of data storage devices whether the claim is to be assigned to a clinical triage consultant for a short-term review or to a case manager for management together with the claim handler;
responsive to determining that the claim is to be assigned to the clinical triage consultant or the case manager, assign the claim; and
notify the another one of the system users via one of the devices accessible to the system users of the assignment.

2. The computer system of claim 1, wherein the rules cause the server to assign a claim from a claim handler to a clinical triage consultant for short term review based on one of time-based triggers and event-based triggers.

3. The computer system of claim 2, wherein the server is configured to permit return of the claim to a claim handler responsive to receipt of data from the clinical triage consultant of a treatment plan.

4. The computer system of claim 2, wherein the event-based triggers comprise one or more of: a request for surgery, total temporary disability without a return to work plan; a diagnosis of carpal tunnel syndrome; an MRI on the neck or the back with a review indicating a condition requiring treatment; or an introduction of a new body site to a claim.

5. The computer system of claim 2, wherein the time-based triggers comprise a first period of time for claims involving medical claims only, and a second period of time for claims involving lost time.

6. The computer system of claim 2, wherein the short-term review by the clinical triage consultant is not more than about 10 days.

7. The computer system of claim 2, wherein the rules cause the server to assign a claim from a claim handler to a case manager based on event-based triggers.

8. The computer system of claim 7, wherein the event-based triggers for assignment to a case manager comprise one or more of: request for spinal surgery; an inpatient hospital stay; a claim of medical causation or relatedness to an underlying injury; a request for a cost projection for a claim; or the additional of multiple non-adjacent body sites to an injury claim.

9. The computer system of claim 1, wherein the system is configured to require closure of a case or assignment of a case by a case manager to a claim handler within a predetermined period.

10. The computer system of claim 9, wherein the system is configured to permit assignment of a case to a claim handler by a case manager upon completion of a case summary, the case summary comprising at least data indicative of: an injury event, an injured individual's age, a diagnosis, instruction/recommendation to the claim handler, and re-open indicators.

11. A computer-implemented method for processing data relating to medical claim management, comprising:
accessing by a claim management hardware server from one or more of a plurality of data storage devices data relating to one of a plurality of medical claims and a system user assigned to the claim for long-term medical management;
determining by the claim management server based on the accessed data relating to the claim and rules data stored in one or more of the plurality of data storage devices whether the claim is to be assigned to another one of the system users for short-term review and a level of the another system user;
responsive to determining that the claim is to be assigned to another one of the users for short-term review, assigning by the claim management hardware server the claim to another one of the system users at the determined level; and
notifying by the claim management hardware server the another one of the system users of the assignment via one of a plurality of devices accessible to the system users.

12. The computer-implemented method of claim 11, wherein the plurality of categories comprise claim handler in one level and clinical triage consultant at a higher level of clinical expertise, and further comprising assigning a claim from a claim handler to a clinical triage consultant for short term review based on one of time-based triggers and first event-based triggers.

13. The computer-implemented method of claim 12, wherein the plurality of levels further comprises case manager at a higher level of clinical expertise than claim handlers, and further comprising assigning a claim to a case manager based on second event-based triggers.

14. The computer-implemented method of claim 13, further comprising closing review by a case manager and returning to a claim handler for medical management responsive to receipt from the case manager of a case summary, the case summary comprising at least data indicative of: an injury event, a diagnosis, instruction/recommendation to the claim handler, and re-open indicators.

15. The computer-implemented method of claim 14, wherein the re-open indicators comprise one or more of a change in medication, a request to a specialist, change in work status, indication for surgery, and reassigning the case to the case manager responsive to receipt of data indicative of occurrence of one or more of the re-open indicators.

16. The computer-implemented method of claim 11, further comprising requiring completion of the short-term review within 24 hours.

17. A non-transitory computer-readable storage medium, the computer-readable storage medium having processor-executable instructions stored thereon relating to processing of data for medical claim administration, which instructions, when executed by the processor, cause the processor to:
access from one or more of a plurality of data storage devices data relating to one of a plurality of medical claims and a system user assigned to the claim for long-term medical management;
determine based on the accessed data relating to the claim and rules data stored in one or more of the plurality of data storage devices whether the claim is to be assigned to another one of the system users for short-term review and the level of experience of the another system user;
responsive to determining that the claim is to be assigned to another one of the users for short-term review, assign the claim to another one of the system users at the determined level of experience; and
notify the another one of the system users of the assignment by providing data indicative of the notification over a network addressed to one of a plurality of devices accessible to the system users.

18. The non-transitory computer-readable storage medium of claim 17, wherein the instructions further cause the processor to:
require input of at least the following data for completion of a short-term review: injury details; return to work (RTW) screen, including estimated RTW date; causal factors and treatment plan.

19. The non-transitory computer-readable medium of claim 17, wherein the instructions further cause the processor to:
prompt a system user to attach or associate electronic documents stored in one or more databases and associated with a claim, including one or more of images of medical records, permanent disability award documents and physical capacity evaluation documents.

20. The non-transitory computer-readable medium of claim 19, wherein the instructions further cause the processor to:
access treatment guidelines for display and review by system users.
